(19) United States
(12) Patent Application Publication
(10) Pub. No.: US 2006/0040087 A1
(43) Pub. Date: Feb. 23, 2006

(54) Method and apparatus for a compact disc with luminescent label

(76) Inventor: Reynaldo Jackson, New York, NY (US)

Correspondence Address: STEVEN HOROWITZ, ESQ., 295 MADISON AVE, SUITE 700, NEW YORK, NY, 10017, US

(21) Appl. No.: 10/923,361

(22) Filed: Aug. 20, 2004

(51) Int. Cl. B32B 37/00; B32B 38/04; B32B 3/02

(52) U.S. Cl. 428/64.1; 156/256

(57) ABSTRACT

A method and apparatus for a compact disc having a luminescent label comprises a compact disc having an annular magnetic surface on a top side thereof, a layer of an opaque adhesive-backed luminescent polyester film coextensive with the magnetic surface directly on top of the magnetic surface, the polyester film having a gauge of approximately 5 mils, a second layer of adhesive, and a display layer coextensive with the luminescent polyester film on top of the luminescent polyester film, the display layer for labeling a tile and/or other indicia of the compact disc.

### FIELD OF THE INVENTION

The field of this invention is luminescent labels, and more particularly, compact discs having luminescent labels.

### BACKGROUND OF THE INVENTION AND DISCUSSION OF THE PRIOR ART

Disc jockeys are frequently called upon to change records scores of times during the course of one evening. Typically, the disc jockey is in the same room as the dancing floor, which is a room that is kept dark to enhance the milieu of the dancing environment. In order to properly select compact discs in the dark, therefore, the disc jockey typically shines a light on each compact disc label that he considers playing in order to locate and identify the compact disc being selected. Given the time consuming nature of the disc jockey's job, the time pressure and multi-task nature of the job, the disc jockey would prefer to being to able to identify the labels without the need to constantly shine a special light on the compact discs. However, the disc jockey would prefer to do so without disturbing the dancing environment lighting.

Presently, disc jockeys typically make errors in identifying the compact disc using the method of shining light on the compact discs. Accordingly, there is a need for a better method and apparatus for reading the labels on compact discs and other music materials in the dark than exists presently, and one that is easier to use than struggling to see the label with a flashlight in one hand.

It should be noted that the phrase “disc jockeys” as used herein need not be limited to those disc jockeys who are professionals or who are paid. It is intended to also encompass amateur disc jockeys and even individuals in their home who are selecting a series of music pieces on compact disc and/or DVD and other similar media for playing. The “club scene” is an environment in which visual effects are considered appealing simply because they are interesting and stylish or “cool” to young people. Disc jockeys may prefer to view a label on a compact disc if the label is visually appealing and interesting due to a particular visual effect that is unique. Thus there is also a need for a way and device for providing a compact disc that has a label with an interesting and appealing visual effect that makes reading the label on the compact disc more appealing.

The term “compact disc” as used herein should be understood broadly to include any data storage media recorded digitally and read by laser or equivalent means, and it is intended to include hitherto unknown digitally recorded storage media that is similar to the above. The term is certainly intended to encompass DVD's even though in ordinary language DVD's and compact discs mean separate things and are used separately.

### SUMMARY OF THE PRESENT INVENTION

A method and apparatus for a luminescent and ornamental compact disc comprises a compact disc having an annular magnetic surface on a top side thereof, an adhesive-backed layer of luminescent polyester film coextensive with the magnetic surface directly on top of the magnetic surface, the polyester film having a gauge of between approximately 0.003 inches and approximately 0.007 inches, a second layer of adhesive, and a display layer coextensive with the luminescent polyester film on top of the luminescent polyester film, the display layer for labeling a tile and/or other indicia of the compact disc.

### IMPORTANT OBJECTS AND ADVANTAGES

The following important objects and advantages of the present invention are:
(1) to provide a method of reading compact disc labels in the dark;
(2) to provide a method of creating ornamental labels for compact discs;
(3) to provide a method of making glow in the dark compact disc labels;
(4) to provide a method of easing the job of disc jockeys in reading compact disc labels;
(5) to provide a method of rendering the reading of labels on compact discs more appealing to a disc jockey;
(6) to provide a compact disc that includes a luminescent label;
(7) to provide a compact disc and label assembly that is appealing for a disc jockey to read;
(8) to provide a compact disc that can be read by disc jockeys in the dark;
(9) to provide a compact disc that can be read without having to shine light on it;
(10) to provide a compact disc that has an ornamental label;
(11) to provide a method and apparatus for enhancing the labels of compact discs without affecting the long term electromagnetic stability of the data on the discs; and
(12) to provide a method and apparatus for illuminating and enhancing conventional labels on compact discs safely.

### BRIEF DESCRIPTION OF THE DRAWINGS

FIG. 1 is a top plan view partly broken away of luminescent compact disc label used in the method of the present invention.

FIG. 2 is a cross-section view taken along line 2-2 of FIG. 1.

### DETAILED DESCRIPTION OF THE PREFERRED EMBODIMENT

The apparatus used in the method of the present invention will now be illustrated by reference to the accompanying drawings. The luminescent compact disc label of the present invention has been assigned reference numeral 10 Other elements have been assigned the reference numerals referred to below.

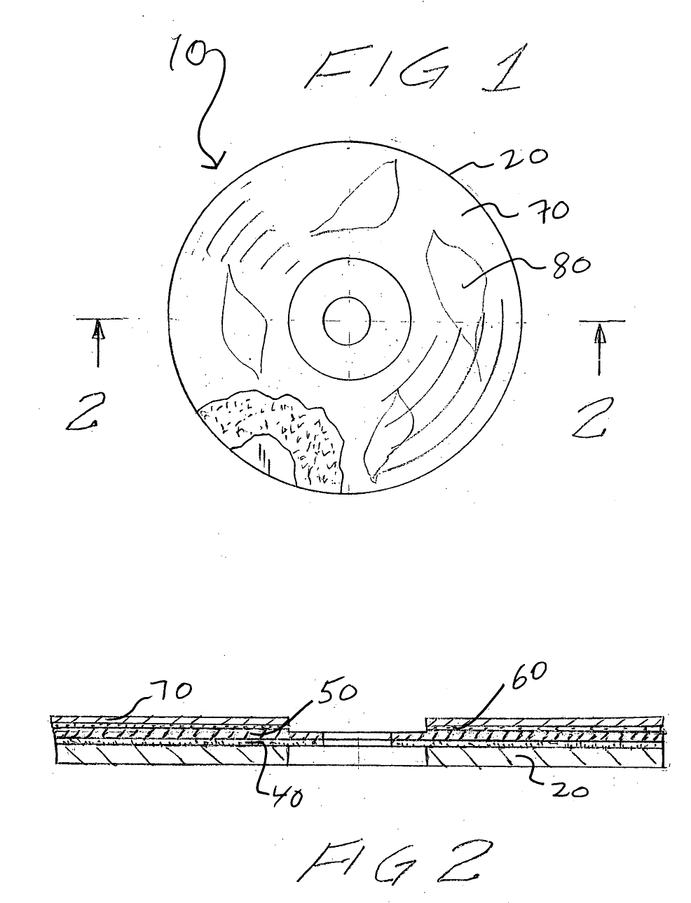

As seen from FIGS. 1-2, a luminescent compact disc 10 is comprised of a conventional compact disc 20 having an annular magnetic surface 30 on a top side thereof, and having a first layer of adhesive 40, a layer of luminescent polyester film 50 coextensive with the magnetic surface 30 directly on top of the magnetic surface 30, the polyester film 50 having a gauge of between approximately 0.003 inches and approximately 0.007 inches, the polyester film in adhering relation to the magnetic surface as a result of the polyester film 50 having an adhesive backing 40 called the first layer of adhesive 40. A second layer of adhesive 60 is above the polyester film 50 and a display layer 70 coextensive with the luminescent polyester film 50 is directly on top of the luminescent polyester film 50 The second layer of adhesive 60 may be a backing to the label 70. The display layer 70 may be a conventional label 70 for labeling a tile and/or other indicia of the compact disc. The display layer 70 thus adheres to the luminescent polyester film 50 as a result of the second layer of adhesive 60.

The layer of luminescent polyester film 50 is manufactured with the first layer of adhesive 40 and the display layer 70 is preferably a conventional label 70 that comes with the second layer of adhesive 60. Hence, the method of the present invention is described comprising the following steps:
(a) providing a compact disc having an annular magnetic surface on a top side of thereof for placement of a label, the annular magnetic surface having a particular shape,
(b) providing an adhesive-backed opaque luminescent polyester film having a gauge of between approximately 3 mils and approximately 7 mils, the polyester film having an adhesive layer on only one side of said polyester film,
(c) shaping the polyester film by cutting the polyester film in order to obtain an annular polyester film whose shape corresponds to the shape of the annular magnetic surface,
(d) placing the annular polyester film over the annular magnetic surface so that the adhesive layer on the back of the polyester film is in contact with the annular magnetic surface and so that the annular polyester film is coextensive with the annular magnetic surface,
(e) placing a conventional label having an adhesive layer on one side thereof over the annular polyester film so that the conventional label adheres to the annular polyester film, thus forming a luminescent compact disc label,
(f) placing the luminescent compact disc label in a dark area, and
(g) reading the luminescent compact disc label.

The steps of the above method are in order only to the extent that they logically have to be. For example, the providing of the compact disc and the providing of the polyester film must obviously precede placing the polyester film on the compact disc.

The polyester layer 50 is not electrically resistant and hence can be combined with the magnetic surface of the compact disc without affecting the electromagnetic status of the disc over the long term.

The polyester layer 50 should be opaque. Ideally, the thickness of the polyester film 50 should be approximately 5 mils.

In a preferred embodiment, the opaque luminescent polyester film 50 is of the kind manufactured by a company called Grafix Plastics, a division of Grafix, Inc., 19399 Miles Road, Cleveland, Ohio 44128, and sold under the brand name Funky Film Glow In the Dark®. This brand is sold retail in stores such as Pearl Paints, Brooklyn, N.Y.

The existence of the luminescent polyester film layer 50 creates an opportunity for manufacturers of labels, or amateurs who are creating labels, to exploit the luminescent feature by planting ornamental designs 80 on the display layer or label 70 that upon illumination would be interesting and visually appealing or “funky” or would otherwise enhance the label 70 so that the label does not merely transmit information about the compact disc 20 but is also ornamental and more appealing.

It is to be understood that while the method and apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A method of enhancing the reading of a label on a compact disc or other similar data storage media, comprising:
providing a compact disc having an annular magnetic surface on a top side of thereof for placement of a label, the annular magnetic surface having a particular shape,
providing an opaque luminescent polyester film having a thickness of between approximately 3 mils and approximately 7 mils, the polyester film having an adhesive layer on one side of said polyester film,
shaping the polyester film by cutting the polyester film in order to obtain an annular polyester film whose shape corresponds to the shape of the annular magnetic surface,
placing the annular polyester film over the annular magnetic surface so that the adhesive layer is in contact with the annular magnetic surface and so that the annular polyester film is coextensive with the annular magnetic surface,
placing a conventional label having an adhesive layer on one side thereof over the annular polyester film so that the conventional label adheres to the annular polyester film, thus forming a luminescent compact disc label, and
placing the luminescent compact disc label in a dark area, reading the luminescent compact disc label.

2. The method of claim 1, wherein providing a luminescent polyester film means providing such a polyester film having a thickness of approximately 5 mils.

3. A compact disc having a luminescent label, comprising:
a compact disc, the compact disc having an annular magnetic surface on a top side thereof,
a first layer of adhesive,
a layer of an opaque luminescent polyester film coextensive with the magnetic surface directly on top of the magnetic surface, the polyester film having a gauge of between approximately 3 mils and approximately 7 mils, the polyester film in adhering relation to the magnetic surface,
a second layer of adhesive directly on top of the layer of luminescent polyester film,
a display layer coextensive with the luminescent polyester film on top of the second layer of adhesive, the display layer for labeling a tile and/or other indicia of the compact disc, the display layer adhered to the luminescent polyester film as a result of the second layer of adhesive.

4. The compact disc of claim 1, wherein the opaque luminescent polyester film has a thickness of approximately 5 mils.
